(19) United States
(12) Patent Application Publication
(10) Pub. No.: US 2009/0138797 A1
(43) Pub. Date: May 28, 2009

(54) AUTOMATED SEQUENTIAL IMAGING OF SELECTED COMPUTER PRODUCED PAGES OF DATA ASSOCIATED WITH DESIGNATED TEXT DATA OBJECTS LISTED ON AUTOMATED PERMUTATIONS OF DATA TABLES

(76) Inventor: Robert Eugene Listou, Washington, DC (US)

Correspondence Address: Robert Listou, 725 3rd St. SW, Washington, DC, 20024, US

(21) Appl. No.: 11/946,647

(22) Filed: Nov. 28, 2007

(51) Int. Cl. G06F 17/24

(52) U.S. Cl. 715/236

(57) ABSTRACT

A computer application providing automated sequential imaging, in user specified order, of selected computer-produced pages comprised of data drawn from records of text data objects listed on a data table, additional data previously entered on the pages and, the ability to display any external image associated with a text data object.

### CROSS-REFERENCE TO RELATED APPLICATIONS AND PATENTS

U.S. Pat. No. 6,134,564
U.S. Pat. No. 6,216,139.

### BACKGROUND OF THE INVENTION

This invention relates to the field of data processing, particularly to computer-produced data tables. The present invention provides a new method for visual examination of data related to text data objects listed on said data tables.

A typical computer-produced data table images the values assigned to parameters of text data objects listed on the data table. Viewing of a plurality of permutations of the data table enables perceptions of a plurality of relationships of parameter values, thus revealing information that cannot be perceived by viewing the single data table. Viewing the plurality of permutations rapidly is necessary because of the limited duration of images in the computer user's short term memory. Said rapid viewing is enabled by the invention described in cross-referenced U.S. Pat. No. 6,134,564, issued to the present inventor. Human analysis of a plurality of said permutations is limited to the name and parameter values unless additional data is already known by the computer user or is made known concurrently. One form of additional data, consisting of concurrent imaging of files related to the listed text data objects, is also enabled by the invention described in U.S. Pat. No. 6,134,564. The present invention provides concurrently additional data to the user of a data table.

### BRIEF SUMMARY

The present invention enables a computer user viewing a computer-produced data table to signal the computer to image a page associated with a selected text object listed on the data table, said page displaying the parameter values of text data objects listed on a data table plus other data related to that text data object. The present invention also enables the user to rapidly view similar pages related to other selected text data objects, said pages being imaged consecutively, automatically or manually, at a speed controlled by the user.

### BRIEF DESCRIPTION OF THE DRAWINGS

FIG. 1 is a data table with the names of listed text data objects in the last column, preceded by columns of named parameters that contain values assigned to the text data objects.

FIG. 2 is a page imaged when the computer user signals the computer to image a new page related to a specified text data object.

### DETAILED DESCRIPTION OF THE INVENTION

The invention described herein and in the referenced patents have a common purpose. That purpose is to assist a user of a table of text data objects in rapidly viewing a plurality of pages which display data about text data objects listed on a data table, close to the speed of thought and with a minimum of operations. That allows the maximum retention of perceived data in the user's short term memory. Reasoning regarding perceived data then occurs with greater use of the user's personal knowledge, skills, intuition, and imagination. That cognitive process was named, by the present inventor, contextual data modeling in cross-referenced U.S. Pat. No. 6,216,139 issued to the present inventor.

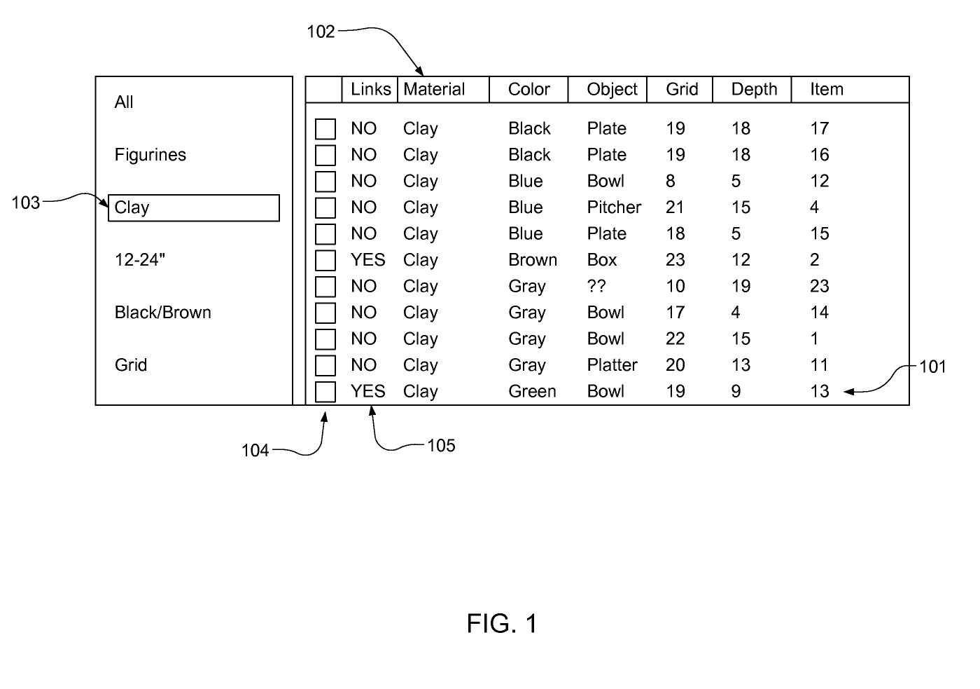

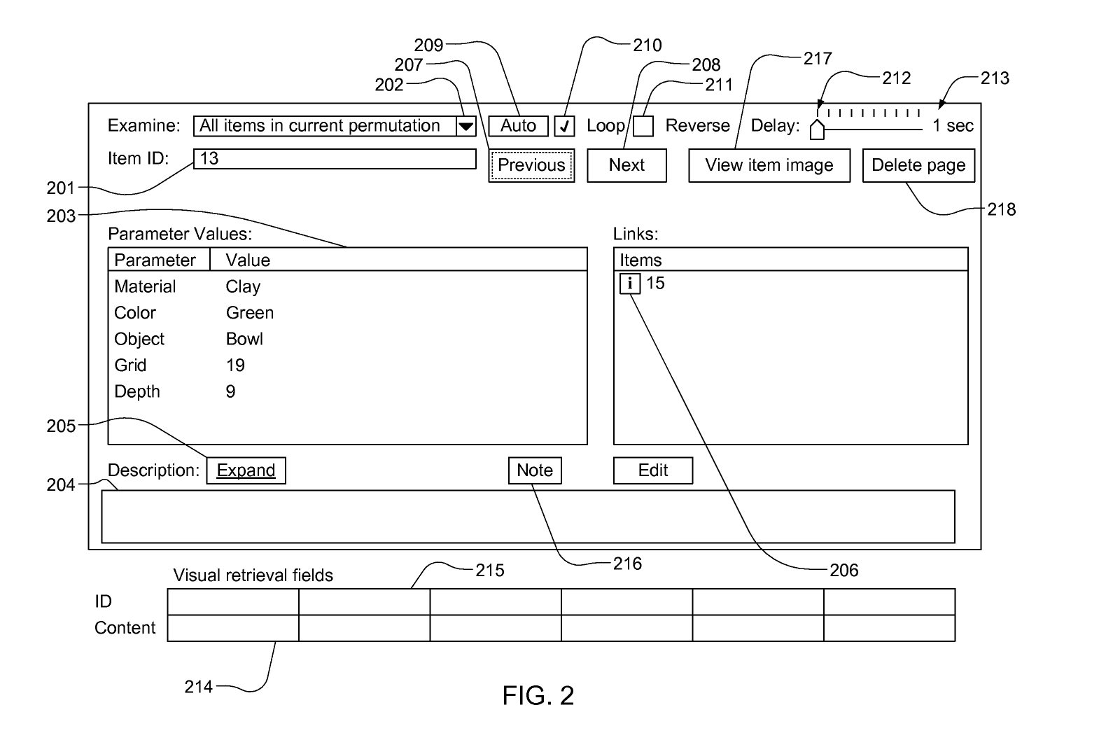

The means for obtaining a computer-produced data table are apparent to those skilled in the art. The present invention employs such means to image a data table such as that in FIG. 1. By clicking the identifier of a listed text data object, such as the number 13 (101) the user instructs the computer to image an item page illustrated by FIG. 2. The Item ID on FIG. 2 at (201) validates the new page. The user now chooses (202) the group of text data objects to be examined, i.e. current permutation, current “query” (combination of criteria regarding material and sort order) or subset of the entire dataset, or entire dataset. The parameters and their values of the current text data item are listed at (203). A further description of the text data object is in the field at (204). The amount of text in (204) is not limited to the space shown, and continuing text can be viewed by clicking (205). Previously determined relationships, or links, between text data objects are indicated individually at (105) and a possible plurality of links, or query, is listed at (206). Clicking such individual (206) listings signals the computer to image the item page of the named object.

The text data objects in FIG. 2 are those meeting the prior entry of the parameter value “Clay” (102) in instructions to the computer regarding type of material of text data objects to be listed on the table. The identity of that particular subset of the complete dataset is imaged at (103), The order of the parameter columns is determined by instructions to the computer entered concurrently with instructions regarding listed material. Such a “query” determines the initial configuration of the text data table. The merit, in the interests of rapid operation, of combining the two criteria on one page was recognized by issuance of referenced U.S. Pat. No. 6,216,139.

Because a plurality of sort orders are possible with a plurality of parameters, each results in a different configuration, or permutation, of the data table. The need to view all possible permutations was addressed in cited U.S. Pat. No. 6,136,564. Similarly, it is necessary to be able to rapidly view the pages such as those in FIG. 2 for selected text data objects on a data table, FIG. 1. Such selection can be all objects in the current dataset, those in a particular query (103) those in the active data table, FIG. 1, or those on that data table that have been marked (104). The selected population chosen at (202) is confirmed. The user then chooses the method of advancement through the pages for the selected population. The method can be manual, by clicking the Previous (207) or Next (208) button, or it can be automatic (209), in which case the advancement can be continuous, or looping (210), i.e. starting over at the end of the series. The user may also wish to view the pages in a reverse order, which can be chosen at (211). The speed of advancement of the pages is determined by a slider (212) and, for future reference, the delay in seconds of the current setting is displayed at (213).

A user rapidly viewing a plurality of pages such as FIG. 2 can be aided by a visual sorting mechanism. Visual retrieval fields (214) can contain text or colors, and as the pages are rapidly displayed sequentially, such markings can be used to distinguish pages in any way the user desires. The identification of each such retrieval field is denoted by a text entry in the adjacent field (215). FIG. 2 does not illustrate the means of affixing colors, said means being known to those skilled in the art.

A user viewing a plurality of pages such as FIG. 2 may wish to add a small temporary note. Clicking (216) opens a small window into which a short text message can be entered, and later viewed by clicking the same button (216). The existence of a note on a page is indicated by text notice adjacent to that button (216) or by a sound made by the computer concurrent with the imaging of that page.

The data about a text data object displayed on a page can be augmented by clicking (217) to image, if present, an image associated with the text data object, such as a letter, map, photograph, or sound-producing file. The user is thus enabled to view concurrently, and edit, imaged data. This feature is described in U.S. Pat. No. 6,134,564 issued to the present inventor.

The user of the invention choosing to eliminate selected pages from the plurality of pages being examined clicks (218) to do so.

It will be apparent to those skilled in the art that the invention described herein increases the scope and integrity of an analysis of any type of text data objects listed on a data table. It will also be apparent that the present invention is not limited to the specific embodiments discussed herein, and that various modifications can be made to this invention without departing from the spirit or scope of the invention.

What I claim as my invention is:

1. A method for using a computer system to display a series of pages of data regarding selected text data objects, wherein each page lists for that object a plurality of parameters and their values, and displays a plurality of other types of data pertaining to that object, comprising:
a. Selecting a group of text data objects;
b. Designating selected objects within the selected group for which associated pages are to be displayed;
c. Sequentially imaging a plurality of pages related to designated text data objects based on image options comprising:
imaging option wherein the time intervals between the sequential imaging of said pages is based on a speed specified by the user, and
imaging option wherein the intervals between the sequential imaging of said pages is based on a manual request by the user, and
imaging option wherein the order of the sequential imaging of said pages can be reversed based on a manual request by the user, and
imaging option wherein the sequential imaging of said pages can be repeated continuously based on a manual request by the user.

2. The method of claim 1 further comprising:
designating pages for deletion from sequential imaging based on selection by the user of one or more choices of:
pages that do not display desired parameter values, and
pages that do not display desired colors or text distinguishing content, and
pages with which no satisfactory image of the text data object is associated, and
wherein the display of colors or text in certain fields, and display of images associated with text data objects, is based on a manual request by the user, and
wherein the deletion of unwanted pages from the current sequence of displayed pages is based on a manual request by the user.
